(19) United States
(12) Patent Application Publication
(10) Pub. No.: US 2018/0290369 A1
(43) Pub. Date: Oct. 11, 2018

(54) Method and Apparatus for Forming a Plastic Work Piece

(71) Applicant: Dana Industries Inc., Etobicoke (CA)

(72) Inventor: John RICCI, Kleinburg (CA)

(73) Assignee: Dana Industries Inc., Etobicoke (CA)

(21) Appl. No.: 15/954,516

(22) Filed: Apr. 16, 2018

Related U.S. Application Data
(63) Continuation-in-part of application No. 13/776,454, filed on Feb. 25, 2013, now abandoned.
(60) Provisional application No. 61/602,955, filed on Feb. 24, 2012.

(51) Int. Cl. B29C 51/42; B29C 35/02; B29C 35/04; B29C 53/04; B29C 53/84

(52) U.S. Cl. CPC B29C 51/424; B29C 35/0266; B29C 53/84; B29C 53/04; B29C 35/045

(57) ABSTRACT

The present invention provides a method of forming a thermoplastic work piece having a deformation temperature. The method comprises locally heating a desired portion, such as a crease line, of the work piece with a stream of a heated fluid, such as a gas, having a temperature at least as high as the plastic deformation temperature of the work piece, and forming the work piece at the heated portion. An apparatus for forming a thermoplastic work piece having a deformation temperature is also provided. The apparatus comprises a heated fluid nozzle operable to deliver a stream of a heated fluid, such as a gas, to a desired portion, such as a crease line, on the work piece to heat the portion to a deformation temperature, and a forming tool for forming the work piece at the heated portion. The method and apparatus involve a conveyor, which rapidly passes the work piece through a sheet of heated fluid to form a line of weakness, which can subsequently be bent and cooled.

### CROSS REFERENCE TO PRIOR APPLICATIONS

The present application is a Continuation in Part of U.S. application Ser. No. 13/776,454, filed Feb. 23, 2013, which claims priority under the Paris Convention to U.S. Application No. 61/602,955, filed on Feb. 24, 2012. The entire contents of such prior applications are incorporated herein by reference.

### FIELD OF THE INVENTION

The present invention relates to methods and apparatuses for deforming a plastic work piece, in particular a thermoplastic work piece.

### BACKGROUND OF THE INVENTION

The ability to controllably form a plastic sheet in a predefined manner is of importance for certain plastic products. For example, controlled forming of a plastic sheet may be used in the manufacture of plastic containers, plastic enclosures, and plastic signage. The forming could be bending, folding, or curling.

Vendors may use signage formed from plastic sheeting to highlight their merchandise to customers and/or to provide such customers with details regarding products. Signs commonly referred to as “shelf talkers” are used by vendors for this purpose. Examples of such shelf talkers are illustrated in U.S. Design Pat. Nos. D627,828, D631,917 and D652,873, the entire contents of which are incorporated herein by reference. This type of signage is typically formed by forming a die-cut plastic sheet to form an anchor portion, for fastening to a shelf, and a sign portion whereupon the information being conveyed to the customer is displayed. In some cases, the sign portion may protrude away from the shelf, sometimes orthogonal thereto, thereby serving to attract an approaching customer before the customer reaches the location of the product. It is particularly advantageous to form the protruding sign portion away from the mounting portion without imparting markings on the forming line, which may be visible when installed at a vendor.

Existing methods of forming plastic sheeting, which generally involve bringing the plastic sheet in contact with a heated metal blade to conductively heat the crease line, result in undesired markings on the area in contact with the blade if the plastic material is overheated. Markings may also be left along the desired forming line if the plastic material was not heated sufficiently to enable it to deform.

Examples of prior attempts at heating plastic materials are provided in the following U.S. Pat. Nos. 4,336,222; 5,288,453; and, 6,309,588. U.S. Pat. No. 6,309,588 teaches the use of heated air to apply heat to a portion of a tube to allow the tube to be bent. However, this references does not teach or suggest any method for bending sheet-like materials.

It is an object of the present invention to obviate or mitigate at least one of the above disadvantages.

### SUMMARY OF THE INVENTION

In one aspect, the present invention provides a method of forming a plastic work piece having a deformation temperature, the method comprising the steps of: locally heating a desired crease line of the plastic work piece with a heated fluid nozzle to at least as high as the deformation temperature; and forming the plastic work piece about the crease line.

In another aspect, the present invention provides an apparatus for forming a plastic work piece having a deformation temperature, the apparatus comprising: a heated fluid nozzle operable to deliver heated fluid to a desired crease line on the plastic work piece to heat the crease line to a deformation temperature, the crease line delineating a first portion of the plastic work piece from a second portion of the plastic work piece; and a forming tool for forming the plastic work piece about the crease line.

Thus, in one aspect, the invention provides a method of deforming a work piece formed of a thermoplastic material, the material having a plastic deformation temperature, the method comprising the steps of:
locally heating a portion of the plastic work piece with at least one stream of a heated fluid, the fluid having a temperature equal to or greater than the plastic deformation temperature of the work piece, wherein the at least one stream of heated fluid is applied in the form of a sheet against a surface of the work piece so as to form a line of weakness on the work piece;
bending the work piece along the line of weakness; and,
cooling the work piece.

In another aspect, the invention provides an apparatus for deforming a work piece formed of a thermoplastic material, the material having a plastic deformation temperature, the apparatus comprising:
a heated fluid nozzle operable to deliver a stream of heated fluid against the work piece to locally heat a portion of the work piece, the heated fluid having a temperature equal to or greater than the plastic deformation temperature of the work piece;
the nozzle having an outlet for shaping the stream of heated fluid into a sheet, wherein the heated portion of the work piece comprises a line of weakness; and,

a forming tool for bending the work piece at the line of weakness.

In another aspect, there is provided a method of deforming a work piece formed of a thermoplastic material, the material having a plastic deformation or glass transition temperature, the method comprising the steps of:
providing at least one of the work pieces on a conveying means;
conveying the at least one work piece in a linear direction under a stream of heated fluid, the heated fluid having a temperature corresponding to the plastic deformation or glass transition temperature of the work piece, wherein the stream of heated fluid is delivered through a slit in a stationary nozzle and applied in the form of a sheet against a surface of the work piece to form a line of weakness on the work piece;
conveying the heated work piece over a form for bending the work piece along the line of weakness to form a formed work piece; and,
cooling the formed work piece at least along the line of weakness to harden the bend.

In another aspect, there is provided an apparatus for deforming a work piece formed of a thermoplastic material, the material having a plastic deformation or glass transition temperature, the apparatus comprising:
a conveyor for receiving and conveying at least one of the work pieces along a linear direction;
at least one stationary nozzle positioned at a first position of the conveyor, the nozzle having a slit and being operable to deliver a stream of heated fluid through the slit in the form of a sheet against the work piece for locally heating a portion of the work piece to form a line of weakness on the work piece;
the nozzle being aligned with the conveyor whereby the length of the slit is parallel to the linear direction;
a form positioned at a second location of the conveyor, downstream of the first position along the linear direction, the form being adapted to bend the work piece along the line of weakness as the workpiece is conveyed there-over;
a cooling station positioned at a third location of the conveyor, downstream of the second position along the linear direction, the cooling station being adapted to cool at least the line of weakness to harden the bend.

### BRIEF DESCRIPTION OF THE DRAWINGS

Embodiments will now be described by way of example only with reference to the appended drawings wherein:

FIG. 1 is a perspective view of a plastic sheet to be deformed.

FIG. 2 is a perspective view of a heated fluid nozzle according to an aspect of the invention.

FIG. 3 is a side view of the heated fluid nozzle shown in FIG. 2.

FIG. 4 is a perspective view of the heated fluid nozzle of FIG. 2 forming a crease line on the plastic sheet.

FIG. 5 is a perspective view of the plastic sheet of FIG. 4 formed to approximately 45 degrees over the heated crease line.

FIG. 6 is a perspective view of the plastic sheet of FIG. 5 formed to approximately 90 degrees over the heated crease line.

FIG. 7 is a perspective view of an unformed plastic shelf talker.

FIG. 8A is a front perspective view of the shelf talker of FIG. 7 formed to approximately 90 degrees over the heated crease line.

FIG. 8B is a rear perspective view of the shelf-talker of FIG. 7 formed to approximately 90 degrees over the heated crease line.

FIG. 9 is a perspective view of an unformed shelf-talker comprising an clip style anchor portion.

FIG. 10 is a perspective view of the shelf-talker of FIG. 9 after being formed.

FIG. 11 is schematic view of a nozzle according to an aspect of the invention and illustrates air flow there-through.

FIG. 12 is a schematic view of a folding machine incorporating the heated fluid nozzle described herein.

### DETAILED DESCRIPTION OF THE INVENTION

The present invention provides a method and apparatus for forming a thermoplastic work piece, preferably, a thermoplastic sheet material. In particular, according to one aspect, the method comprises heating a thermoplastic sheet material at a discrete location, preferably along a line, or “crease line”, to form a zone of weakness, along which the work piece is to be bent. The method comprises the use a nozzle having a slit to provide a sheet of a heated fluid to heat the work piece at the desired location to form the zone of weakness. An apparatus according to an aspect of the invention comprises a heated fluid nozzle to heat a thermoplastic work piece, preferably along a discrete line, or “crease line”, and a forming tool for forming the plastic work piece about the crease line.

Although examples are laid out with reference to using a plastic sheet, is will be appreciated that a variety of plastic work pieces may be formed using the method described herein. For example, the plastic work piece may be a sheet, a film, a strand, a bar, a pipe, a tube, etc. However, the invention is particularly suited for work pieces that are of a sheet form.

As used herein, the term “plastic sheet” will be understood to comprise any thin plastic material, in particular a thermoplastic material, that can be locally heated along a line to enable plastic deforming of the material along the line. The thickness of the work piece, for example the plastic sheet, is typically on the order of millimetres or fractions of millimetres. However, it will be understood that a work piece, for example, a plastic sheet, having any thickness that can be formed using the method or apparatus described herein.

The term “deforming” or “forming” as used herein may refer to bending, curling, folding or otherwise imparting, removing, or changing an angle between two portions of a work piece. The term forming may, more generally, refer to any process to plastically deform the work piece. As will be understood by persons skilled in the art, the term “plastically deform” refers to a process by which the shape or size of an article is permanently changed without breaking the article. As will be understood, plastic deformation of a thermoplastic material is typically achieved by application of heat to form a zone of weakness, followed by a deformation step.

As known to persons skilled in the art, it may be desirable to form the plastic sheet to include a bend of any angle, for example the angle may be between 0 degrees and 180 degrees in either direction from the plane of the unformed plastic sheet. For example, the plastic sheet may be formed to form an acute angle, a right angle, or an obtuse angle. The present invention provides an apparatus and a method for controllably forming a plastic sheet to any specified angle.

The plastic sheet for which the invention is designed may be formed from any thermoplastic material, that is a material that can be deformed upon application of heat above the material's deformation temperature. For example, the plastic sheet may be a thermoplastic and the deformation temperature may be the glass transition temperature. The thermoplastic may, for example, preferably be polyvinylchloride (PVC), although other materials will be apparent to persons skilled in the art in view of the present description.

For example, if a crease line of a thermoplastic sheet is heated to a temperature at least as high as the glass transition temperature of the thermoplastic sheet, the sheet may be controllably bent along the crease line. The crease line may then cool or be cooled to a temperature below the glass transition temperature to enable the plastic sheet to retain its formed form.

Using a heated metal blade to locally heat the crease line is problematic in certain applications due to the white markings that may be formed if the area of the crease line in contact with the metal blade overheats. It is particularly advantageous to avoid these white markings in applications in which the aesthetic properties of the plastic sheet are important (e.g. when forming plastic signage). To reduce the likelihood of forming markings, the present invention provides a heated fluid nozzle that imparts heated fluid, such as air or other low-viscosity fluid to the desired crease line. For example, the heated fluid nozzle may deliver a stream of a heated gas such as heated air, nitrogen or heated carbon dioxide, depending on the application.

The heated fluid nozzle provides convective heating to the crease line of the plastic sheet. Convective heating of the crease line enables the control of several parameters relevant to the heating of the crease line and therefore, the forming of the plastic sheet. For example, the temperature of the fluid delivered by the heated fluid nozzle, the thickness of the heated fluid nozzle, the rate of fluid flow through the heated fluid nozzle, as well as the geometry of the heated fluid nozzle may all be configured to suit the particular application.

The heated fluid nozzle delivers a heated fluid to the crease line to locally heat the crease line. Two or more heated fluid nozzles may be provided to heat a crease line. For example, the crease line of a plastic sheet having a top surface and a bottom surface may be heated by a first heated fluid nozzle located proximal or adjacent to the top surface of the plastic sheet and a second heated fluid nozzle located proximal or adjacent to the bottom surface of the plastic sheet. In this manner, the first nozzle applies a heated fluid to the top surface of the sheet while the second nozzle applies a heated fluid to the bottom surface of the sheet. Ideally, both nozzles would apply their respective heated fluid simultaneously.

The dimensions of the heated fluid nozzle may be provided based on the desired radius of curvature of the bend of the plastic sheet. Preferably, the heated fluid nozzle locally heats the crease line while the plastic sheet at either side of the crease line remains at a temperature lower than the deformation temperature. For a sharply formed plastic sheet, for example, the width of the heated fluid nozzle may be on the order of millimetres. That is, the nozzle through which the heated fluid stream passes, will be sized to match the crease to be formed. For example, the heated fluid nozzle may have an outlet that is 1 mm wide. For a plastic sheet that is to be formed with a larger radius or crease, the outlet of the heated fluid nozzle may be wider. The outlet of the heated fluid nozzle may also be thinner than the intended crease line but can be moved perpendicularly to the crease line while imparting heated fluid on the crease lines so as to enlarge the heated region. If a wide crease line is desired in a particular application, the heated fluid nozzle may also heat the crease line for a longer period of time to enable the heated crease line to heat the adjacent plastic sheeting.

By way of example, a clear sheet of 0.5 mm polyvinylchloride (PVC) initially at 21° C., may be deformed by applying a 2 mm wide heated fluid stream at a temperature of 66° C. to 93° C. to heat the crease line to 66° C.

Emitting fluid at the higher end of the 66° C. to 93° C. temperature range enables the crease line to reach the 66° C. deformation temperature at lower fluid velocities, reducing the likelihood of wrinkling developing in the plastic on a high speed production line. Once the crease line has been heated, the plastic sheet may be formed over the crease line and cooled to harden the crease line at the desired form angle. The plastic sheet may be formed using a mechanical forming tool, for example, a plastic sheet line bender. The plastic sheet may also be formed manually.

The heated fluid nozzle of the invention may be retrofitted onto an existing commercial plastic sheet former to replace the heated metal blade typically found on such formers. The heated fluid nozzle of the invention may also be installed on a production line.

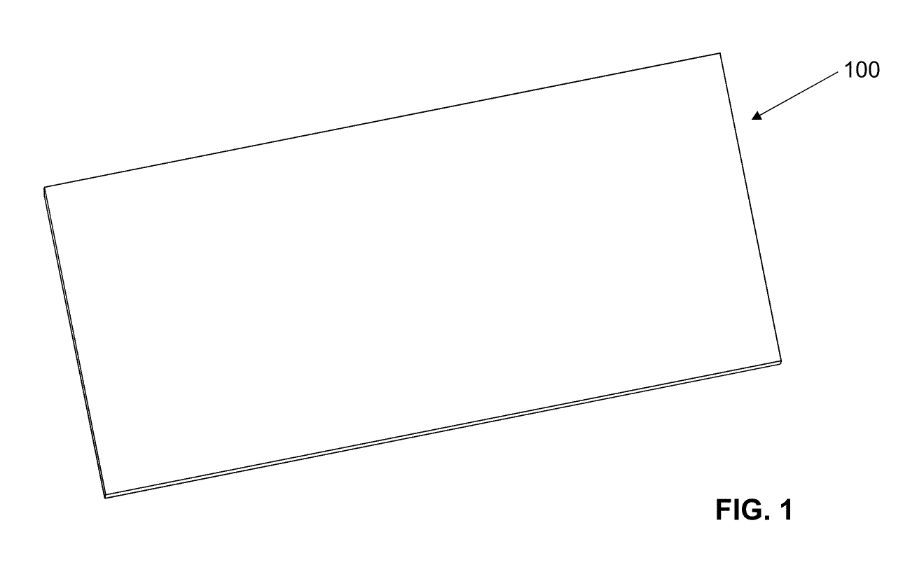

Turning to FIG. 1, an example plastic sheet 100 is shown. The plastic sheet may comprise any suitable thermoplastic. The thickness of the plastic sheet may range from a fraction of a millimetre to several millimetres. Although the plastic sheet 100 of FIG. 1 is shown as a rectangular sheet, it can be appreciated that the plastic sheet 100 may be of any configuration and/or geometry in which the crease line may be heated using a heated fluid nozzle.

The plastic sheet 100 may have already been formed along one or more crease lines. The plastic sheet 100 may also comprise one or more curved and/or rounded surfaces. For example, the plastic sheet 100 may have previously been formed along one or more crease lines according to the method described herein. The plastic sheet 100 may also comprise features formed using other plastic forming methods.

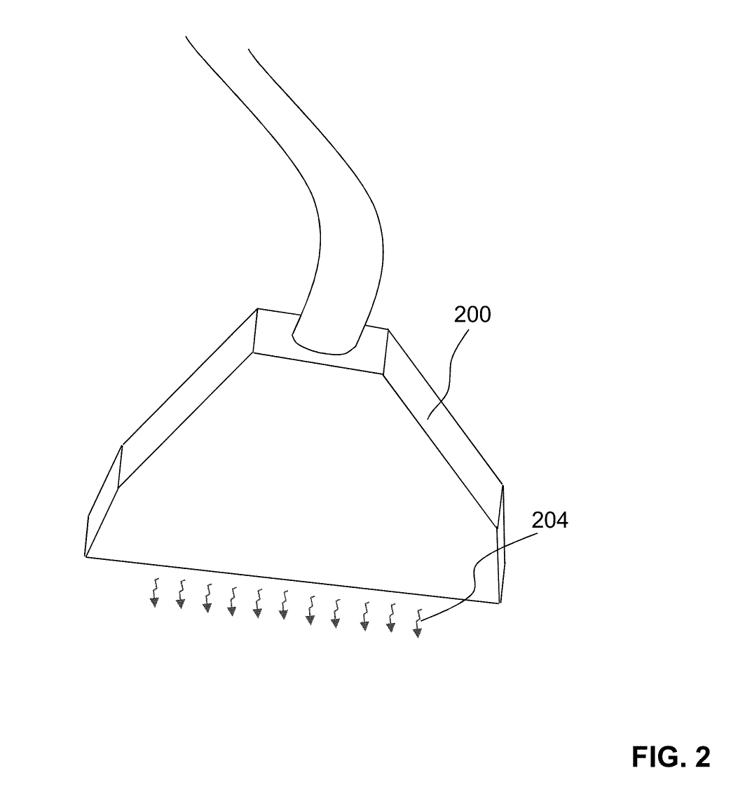

Referring to FIGS. 2 to 4, there is shown a heated fluid nozzle 200 operable to deliver a stream of heated fluid 204 through an outlet to a crease line 202. As will be understood, the outlet of the nozzle 200 will comprise a slit so as to conform the stream of the heated fluid to the crease line 202. Although a particular geometry of the heated fluid nozzle 200 is shown in FIG. 2, it can be appreciated that any configuration of the heated fluid nozzle 200 that provides a controlled and directed stream of fluid to a plastic sheet may be used. The configuration of the heated fluid nozzle 200 in FIG. 2 is advantageous for heating a long and narrow region of a plastic sheet, consistent with a crease line, enabling long sheets to be formed.

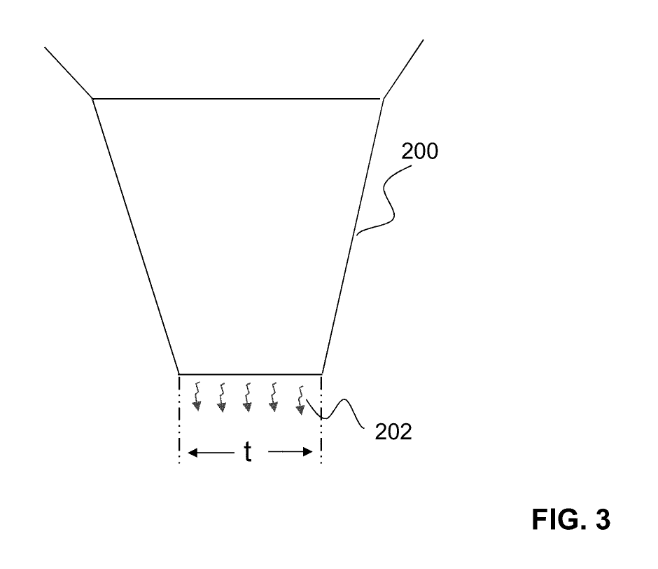

Turning now to FIG. 3, a side view of the heated fluid nozzle 200 is shown. The section shows the heated fluid stream having a thickness, t, which may be significantly thinner than the length of the stream. As was described above, the thickness, t, of the heated fluid stream, which generally corresponds with the width of the outlet provided on the nozzle, may be in the range of millimetres, whereas the width of the stream would be much greater. For example, the thickness t may be 1 mm. However, it will be appreciated that the outlet of the nozzle can be changed or adjusted to provide a thinner or thicker stream of heated fluid, depending on the characteristics of the plastic sheet that is to be formed as well as the desired degree of bending (i.e. the radius of the form).

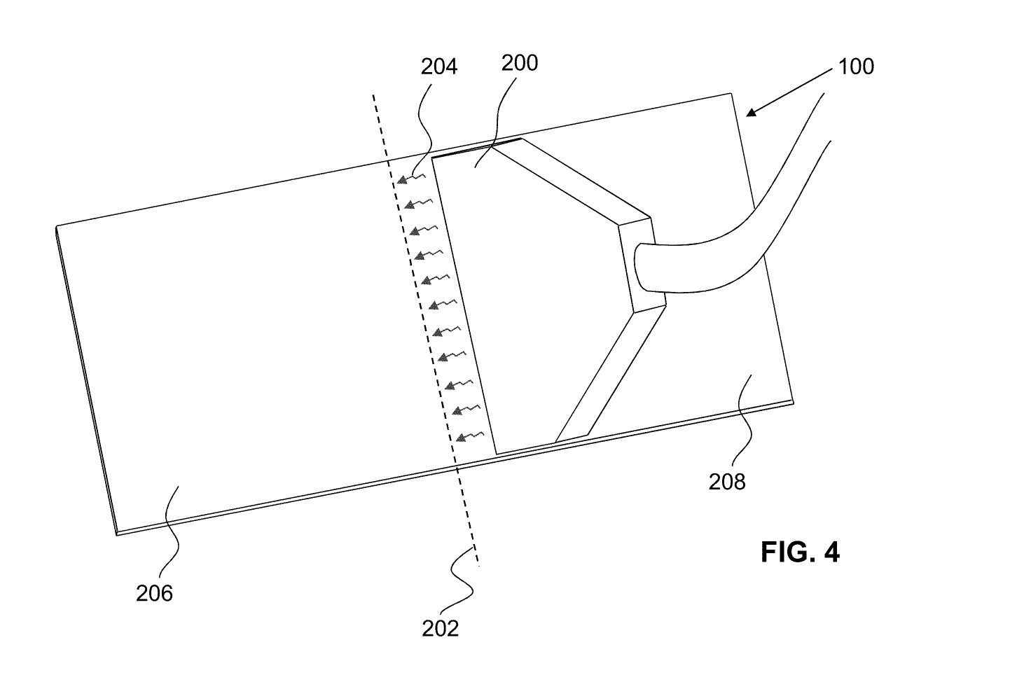

Referring now to FIG. 4, the plastic sheet is shown with a crease line 202, which divides the plastic sheet into a first portion 206 and a second portion 208. The crease line 202 may optionally be demarked by markings on the plastic sheet 100 itself or by markings on a surface on which the plastic sheet 100 lies. The heated fluid nozzle 200 includes an outlet and is operable to deliver a stream of heated fluid 204 to the crease line 202. As outlined above, fluid imparted on the crease line 202 by the heated fluid nozzle 200 heats the crease line 202 to at least the deformation temperature before the plastic is formed over the crease line 202. The plastic sheet 100 may then be mechanically formed to a particular angle and cooled to impart the plastic sheet 100 with a permanent form, or bend about the crease line 202.

The heated fluid nozzle 200 may be stationary with respect to the crease line 202 throughout the heating process or may move towards and away from the crease line 202 or translate perpendicularly to the crease line 202 along the plane of the plastic sheet 100 while heating the crease line 202. In this way, the size or width of the crease line can be adjusted as needed.

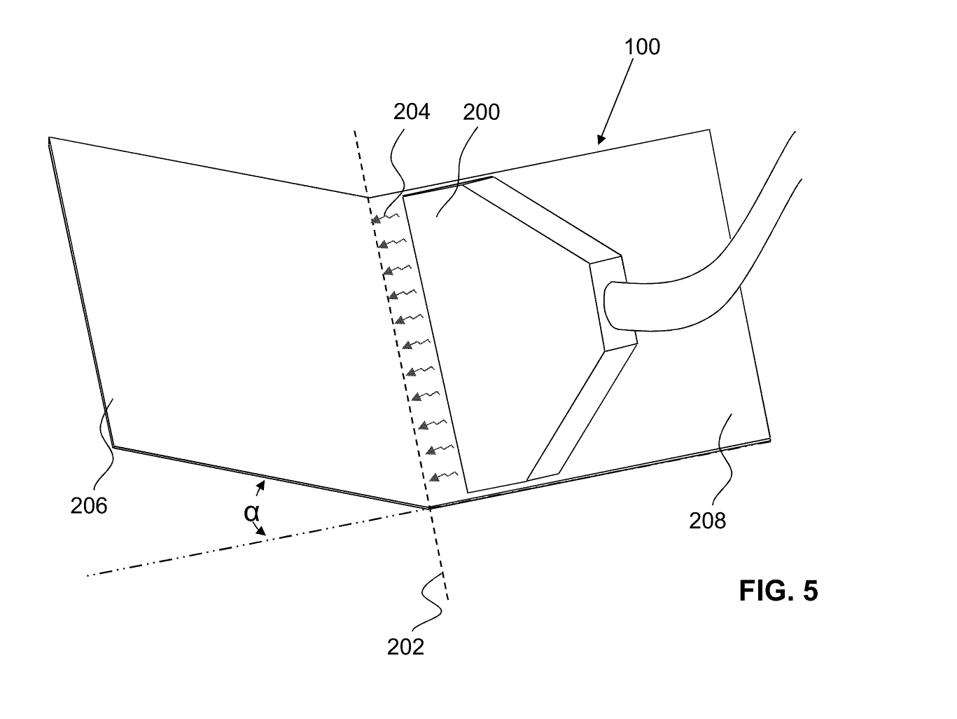

Referring now to FIG. 5, the plastic sheet 100 of FIG. 4 is shown after the first portion 206 is mechanically formed at an angle α (alpha) relative to the second portion 208, over the crease line 202. As indicated above, such angle is obtained by heated the material at the crease line to a predetermined temperature using the heated fluid stream of the nozzle 200. The heated fluid nozzle 200 may continue to heat the crease line 202 during the forming process. Alternatively, the heated fluid nozzle 200 may cease heating the crease line 202 prior to the forming process or part way through the forming process. If the final desired form angle is greater than angle α, the mechanical forming procedure may continue past this angle. A forming tool (not shown) may be used to form the plastic sheet to any desired angle about the crease line. The forming tool may comprise a plate, supporting first portion 206, and which can be pivoted so as to bend the work piece at the crease line 202.

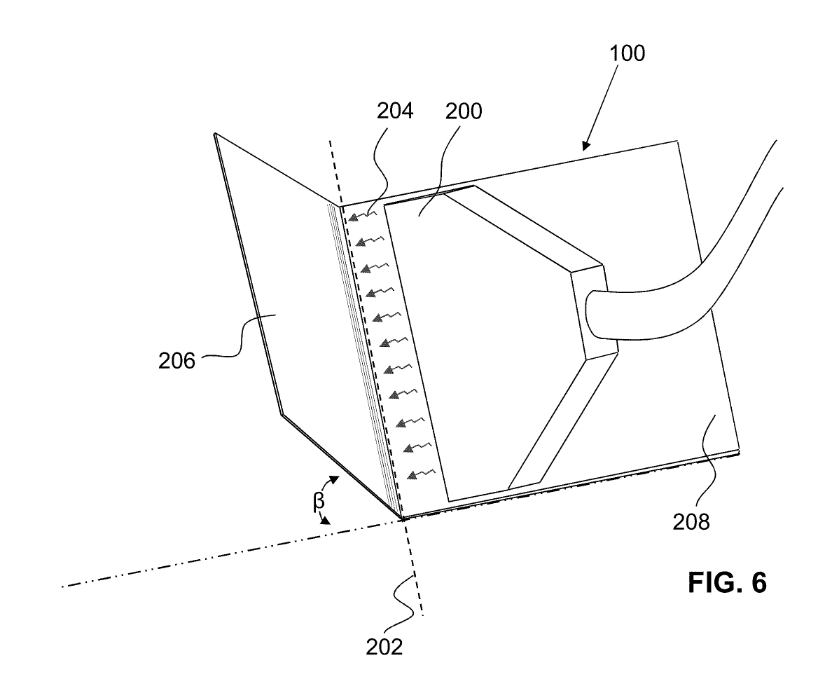

Turning to FIG. 6, the plastic sheet 100 of FIG. 5 is shown formed to an angle β (beta). As can be appreciated, the form angle may be any angle between 0 degrees and 180 degrees. Once the angle between the first portion 206 and the second portion 208 reaches the desired form angle, the mechanical forming procedure may stop and the crease line may be cooled to harden the plastic and thereby preserve the formed structure of the plastic sheet 100.

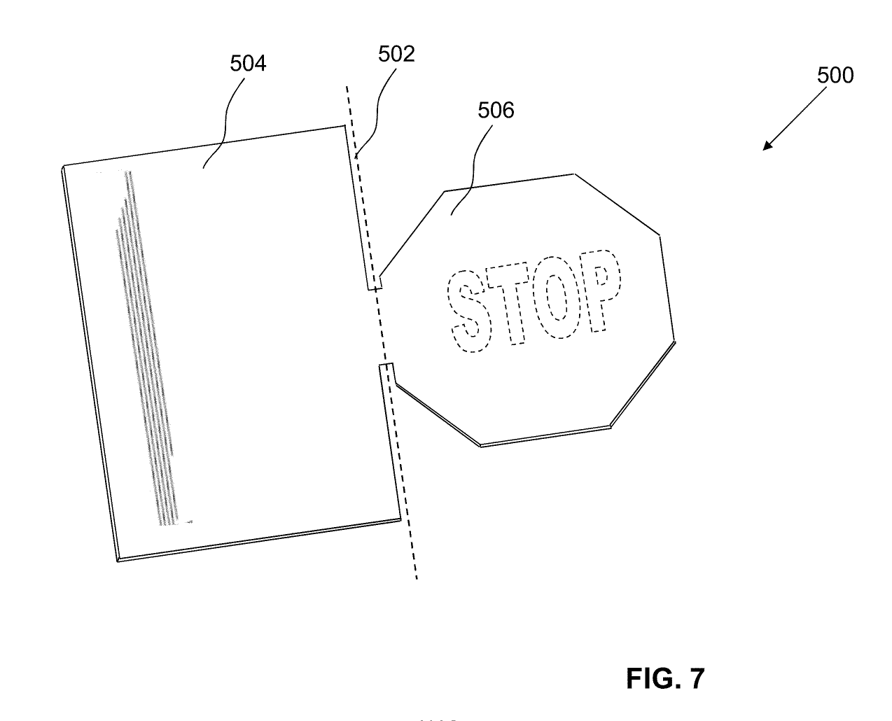

Referring now to FIG. 7, a plastic sheet is shown that is designed to be formed into a shelf talker 500. Although the form of the shelf talker differs from that of the plastic sheet of FIG. 1, the general principles behind the forming of the shelf talker over the crease line 502, which divides an anchor portion of the shelf talker 504 from a sign portion 506, are similar.

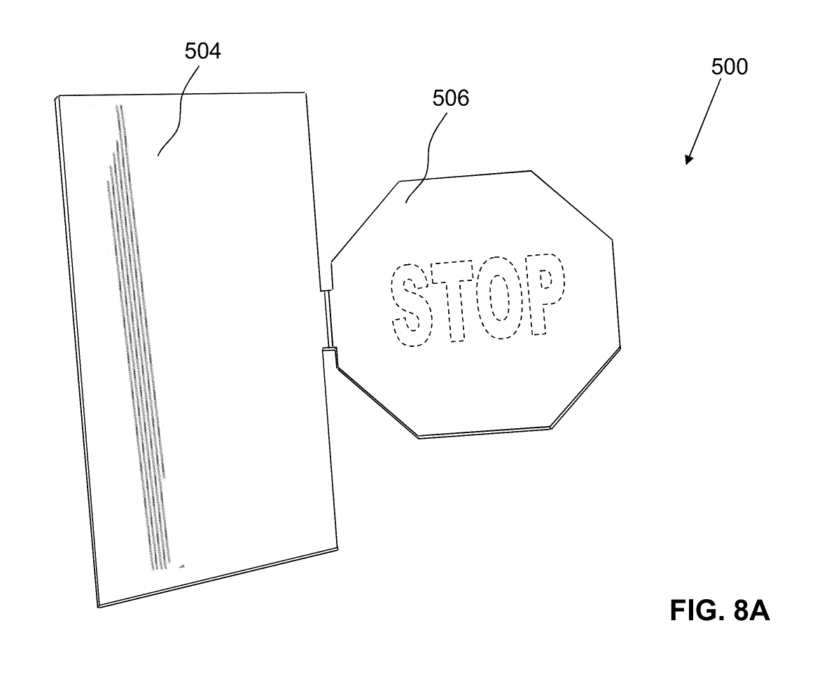

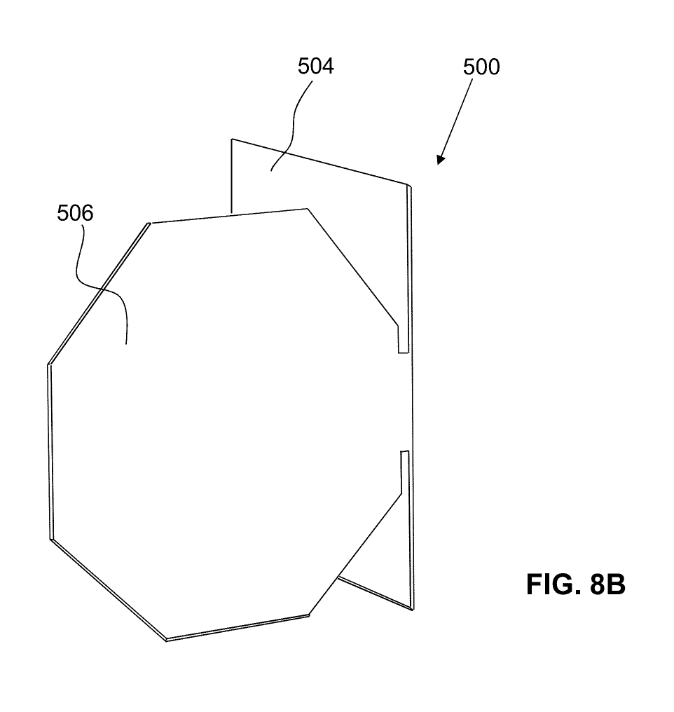

Turning to FIG. 8A, the shelf-talker of FIG. 7 is shown formed to include a right angle about the crease line 502 using the principles described in FIG. 4 and FIG. 5. In this configuration, the anchor portion 504 may be coupled to a shelf while the sign portion 506 may protrude perpendicularly from the shelf to attract a customer's attention. FIG. 8B shows the shelf talker 500 from the rear side. The sign portion 506 may comprise an advertisement or other indicia on one or both sides. In the example of FIG. 8A and FIG. 8B, the shelf talker 500 is provided with indicia on only one side.

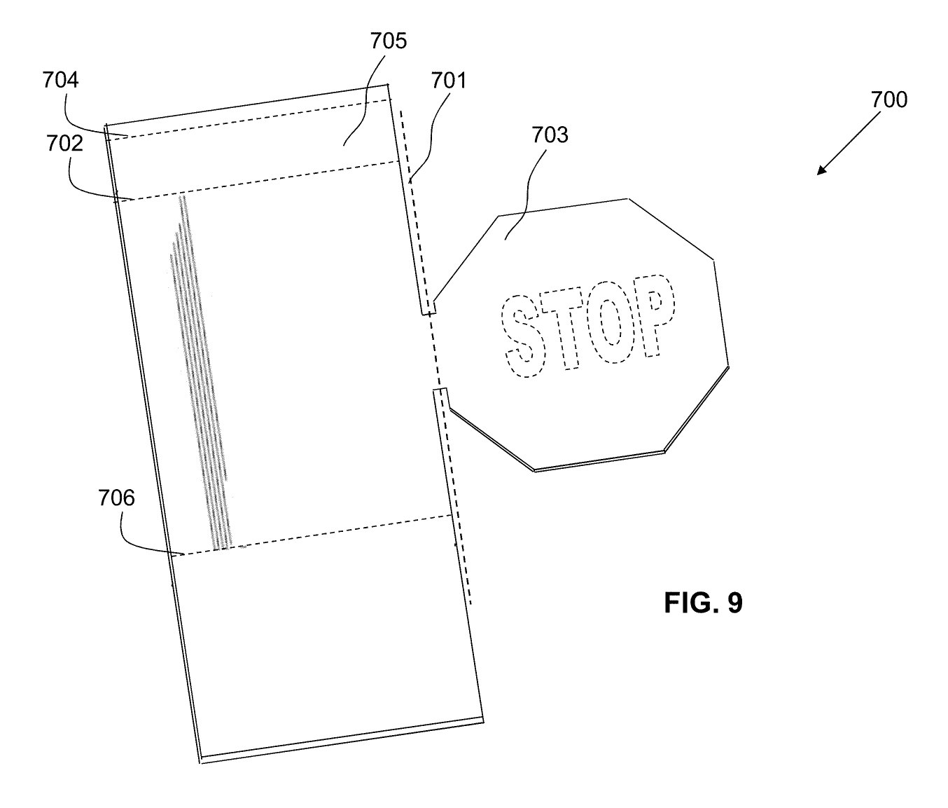

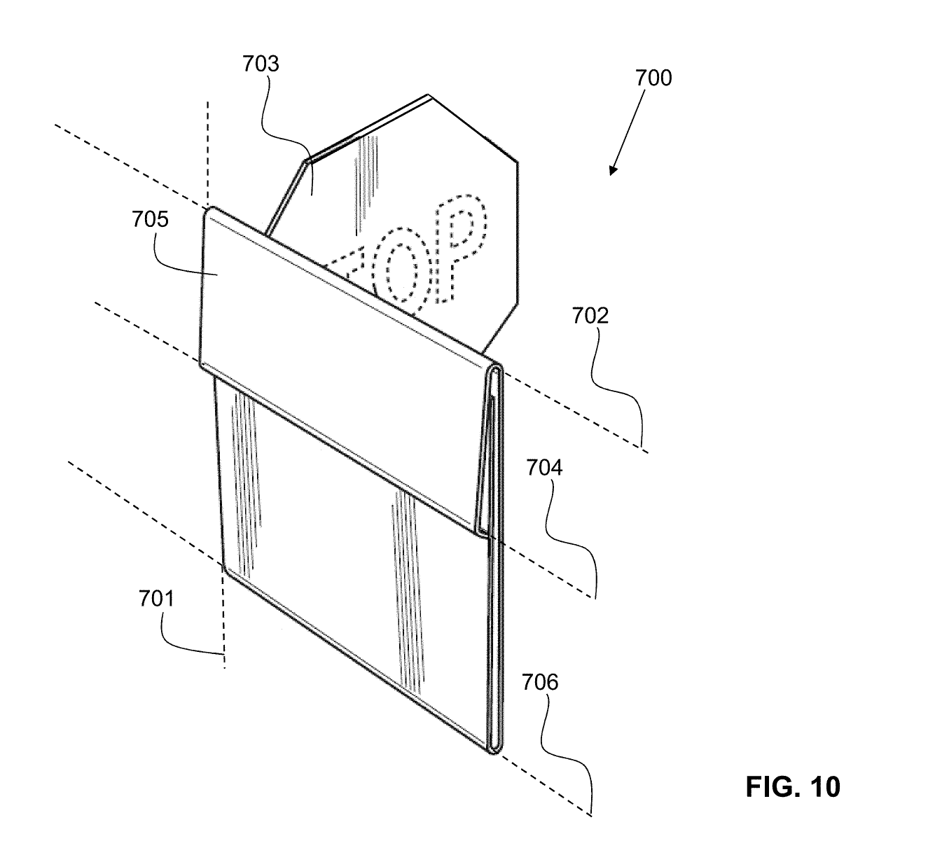

Referring now to FIG. 9 and FIG. 10, a shelf-talker 700 is shown with an unformed clip-type anchor portion 705, as well as a sign portion 703 that is similar to the sign portion 506 of the shelf talker in FIG. 7. The clip-type anchor portion 705 may be formed by forming the anchor portion along three different crease lines, 702, 704, and 706. In particular, the anchor portion 705 may be formed, according to the method outlined above, by heating and folding crease line 706 by approximately 180 degrees. As will be understood, such an angle or fold will result in the anchor portion 705 having a two layer structure. The anchor portion 705 may be provided with a clip by folding crease line 704 by an angle, such as an angle of approximately 60 degrees. Crease line 702 may also be folded by 180 degrees. Additionally, the sign portion 703 may be made to protrude from the anchor portion 705 by forming the sheet along the crease line 701 which divides the anchor portion 705 from the sign portion 703.

Turning now to FIG. 10, the shelf talker 700 of FIG. 9 is shown in the formed orientation. It may be desirable to heat and form the shelf talker over the crease lines individually or it may be desirable to heat all crease lines concurrently prior to forming, which may be done using a single heated fluid nozzle or a plurality of heated fluid nozzles.

As can be seen from FIG. 10, successive forms on a single plastic sheet can form complex and functional structures. In comparison with plastic sheeting formed using a heated blade, a heated fluid nozzle provides clean forms with minimal discoloration around the crease lines. In particular, the crease line 701 between the sign portion 703 and the anchor portion 705 of the shelf-talker 700 may be formed without imparting white markings along this crease line 701. Avoiding white markings on the crease line 701 is particularly advantageous, as the crease line 701 may be visible to the customers of a vendor who makes use of the shelf-talker 700.

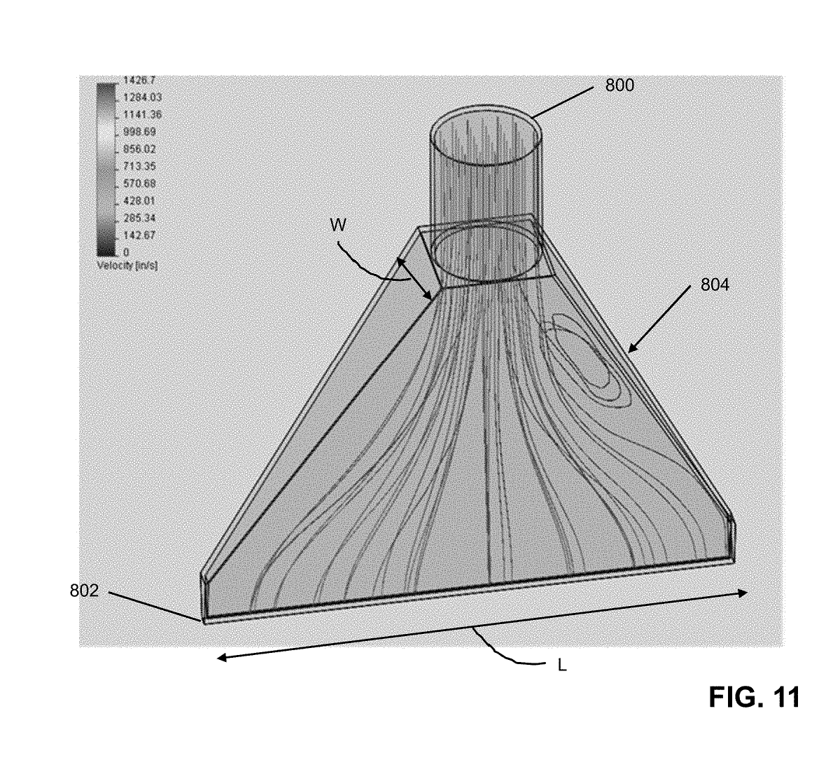

As will be appreciated by persons skilled in the art, the present invention offers various advantages over known methods. For example, the invention provides a thin sheet of heated fluid, in particular air, which essentially acts like an “air blade”. A preferred nozzle design is illustrated in FIG. 11. As can be seen, the nozzle includes an inlet 800 having a generally circular cross section, which is designed to allow a stream of heated air to enter. The nozzle also includes an outlet 802, which, as described previously, comprises a narrow slit. The body 804 of the nozzle has a width, W, and thickness that narrows from the inlet 800 to the outlet 802. The body 804 also has a length, L, which increases from the inlet 800 to the outlet 802. In this way, the air velocity exiting the nozzle is greater than air velocity entering the nozzle. Such a structure for the nozzle aids in providing the aforementioned “air blade” characteristic.

The sheet of air, or “air blade”, acts on a discrete section of a plastic sheet so as to cause a linear zone of weakness, enabling the work piece to be folded or bent at the weakened zone. After cooling, the bend is permanently provided on the work piece. As discussed above, prior art methods of providing a bend on plastic sheet involved the application of a heating element. However, contact with such heating element results in a disfigurement of the work piece. This disadvantage is avoided by the method of the present invention. As discussed above, the present invention is particularly suited for application to a thermoplastic material, that is, a material that is plastic, or deformable, upon application of heat. Such material will be understood to have a deformation temperature at which deformation begins. The deformation temperature will be understood to comprise a range, with such range not extending to a temperature that results in melting or damage to the material.

By using an “air blade” another advantage is realized with the present invention, namely the creation of a desired, narrow zone of weakness. For example, with known heating devices, a heating element is used. As will be understood, with such elements, it is very difficult to achieve a narrow line or zone of weakness, since the heat would be transferred to a relatively wide region, thereby resulting in the work piece having a wide bending area. By contrast, a narrow line of weakness, as achieved with the method and apparatus of the invention allows a narrow bend to be formed on the work piece and, therefore, a more aesthetically appealing formed article.

As noted in the example discussed below, the presently described apparatus and method is particularly suited as a “box folding” type of machine and method. As would be understood, a box folding machine comprises a continuous feed where box blanks are fed, in a flat orientation at the outset, to one or more folding stations where the desired folds are provided thereby resulting in the box. In the presently described apparatus, as illustrated by the example, a number of work piece blanks are subjected to heating by passing such blanks under a stationary nozzle (as described above). As also described above, the nozzle applies a constant sheet of heated fluid (e.g. air) in the form of an air blade. As the work piece blanks are passed under the nozzle, a discrete linear zone of weakness is provided on the work piece in the same manner as discussed above. The work piece is then subjected to the desired bending. In one aspect, this bending may be accomplished by passing the work piece with the zone of weakness immediately through a forming section of the machine. The forming section may comprise a curved form or guide, which bends one section of the work piece in relation to another section thereof, whereby the work piece is bent at the linear zone of weakness. After the desired bend is formed, at least the zone of weakness is cooled and the bend is thereby retained permanently.

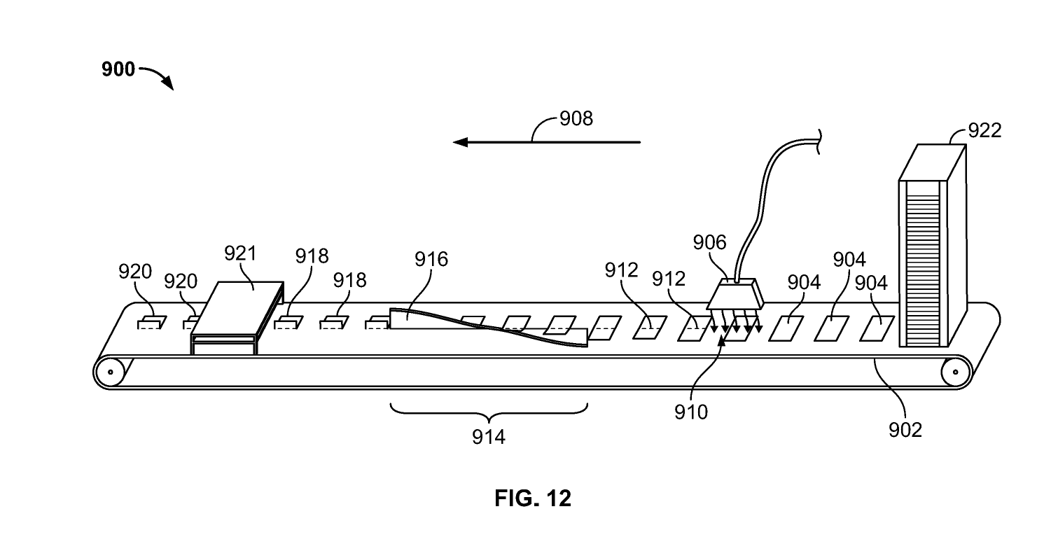

One example of the aforementioned folding apparatus is illustrated in FIG. 12. As shown, the apparatus 900 comprises a conveyor or conveying means, such as a conveyor belt 902 for conveying blanks 904 of the work piece to a nozzle 906. The nozzle 906 has the same configuration as that described above. As described earlier, the nozzle 906 is designed to deliver a defined sheet of heated fluid, such as air. Such sheet is referred to herein as an “air blade”. As also described above the nozzle 906 is supplied with a source of heated fluid, which is not shown in FIG. 12 for convenience. The air blade comprises a sheet having a discrete and pre-determined thickness, which corresponds generally to the width of the line of weakness that is desired to be formed on the work piece. As shown in FIG. 12, the nozzle 906 is stationary with respect to the conveyor 902. The conveyor is adapted to move the blanks 904 along a path shown by the arrow 908. As can be seen, in this way, the conveyor carrying a given blank 904 is adapted to pass the blank 904 under the air blade 910 of the nozzle 906. In the result, each blank 904 is provided with a line of weakness shown schematically at 912. After passing under nozzle 906, and being subjected to the air blade 910 heating, each blank is then bent about the line of weakness 912 by passing the heated blank through a forming section 914. In one aspect, the forming section comprises a stationary forming guide or wall 916. As shown, the guide 916 serves to bend the work piece as it is passed there-over. As would be understood, the forming step is conducted while the line of weakness on the work piece is still in a formable state. In the preferred aspect, the guide 916 is designed in the form of a gently curved wall so that the bend on the work piece can be formed smoothly. Once the necessary bend is formed, the formed work piece 918 is cooled at least the line of weakness to harden the bend and result in the finished, formed product 920. The cooling may be accomplished with another blower or fan, or in a cooling chamber such as that shown at 921. Any form of cooling may be used in the apparatus shown. The formed product 920 may then be removed off the conveyor 902 with another apparatus or manually. In one aspect, the blanks 904 may be fed to the conveyor 902 by means of a hopper or blank dispenser 922 or other similar feeder device that serves to load work piece blanks 904 onto the conveyor 902. It will be understood that the work pieces 904 may also be manually loaded onto conveyor 902.

The apparatus and method as described above allows rapid heating and forming of the work piece, particularly due to the unique arrangement of the air blade as illustrated in FIG. 12. That is, by heating only a very discrete region of the work piece, by forming a discrete line of weakness, the bending process is facilitated. Further, as discussed above, the use of the air blade to heat the work piece material to the required temperature (such its plastic deformation or glass transition temperature), avoids the damage and discolouration typically associated with known processes that utilize radiant heating by a heating element. The described system and method also results in a very discrete heated seam without heating and/or otherwise affecting the remaining portions of the work piece. As a result, the described system and method allows for a very high rate or processing of work pieces, such as about 10,000 units per hour, as noted in the example below.

Although FIG. 12 illustrates the presence of one nozzle 906, it will be appreciated that the apparatus can be provided with any number of nozzles as needed. For example, by arranging a series of nozzles and bending/cooling stations along the length of the conveyor, it would be possible to form any number of bends on a given work piece in a continuous manner. Similarly, the workpieces can be processed through any number of apparatuses to result in the desired number of bends.

### Example

The following example is provided to illustrate an application of the invention. It will be understood that the example is not intended to limit the scope of the invention in any way.

The Challenge

To heat defined strips on a piece of clear PVC approximately 0.4 to 0.5 mm in thickness, and fold the piece into a defined shape using box folding machine methods.

The strips were 1-2 mm in thickness. The goal was to heat the strips to 150° F. along a line, while leaving surrounding areas cool. The temperature of 150° F. is the temperature at which PVC material can be plastically deformed. Once it cools, the material sets to the new, formed shape.

The PVC should not be contacted by a heating element, as white markings can be left. Markings will also be left if the material is not heated enough.

Heat Transfer Methods Comparison

Various types of heating methods were considered, each of which is described below.

Thermal Radiation

Thermal radiation transfers energy to the material. However, since the plastic used is often clear, it would not absorb much of this energy. This method has been tested and found ineffective for the types of materials used to form articles such as shelf talkers.

Convection

Convection heat transfer uses a fluid (such as air) to carry the heat energy to the desired location. This gives a number of values that can be controlled:
temperature of the fluid
temperature and area of the heating element(s)
rate of fluid flow
nozzle design

This is the preferred method for the present invention, as the variables involved can be adjusted to suit the process and minimize dangers.

Various types of heating elements can be used to heat the air, such as quartz tube heaters, wire-type heating elements or finned tubular heaters. The latter is more robust and are used in industrial dryers and curing ovens and can support air temperatures of up to 500° F.

Conducts occurs when heat travels through a material, such as when one end of a metal bar is heated, and the heat is transmitted to the other end. Experiments have shown that it is possible to make the process work using a quartz tube heater. These heaters are long lasting. Although the quartz tube must be located within 3-5 mm of the plastic, it is possible to use a mask to heat only the defined strip.

Power Requirements

Based on the material properties, it is possible to calculate the heat energy required to raise the PVC material to the required temperature, as described in the following table:

Heat Energy Required to soften PVC

| Width of heat zone | 2 | mm |
|---|---|---|
| Thickness | 0.5 | mm |
| Unit Volume length | 1 | mm |
| Starting Temp | 21 | C. |
| Finishing Temp | 150 | F. |
| | 65.56 | C. |
| Delta T | 44.56 | |
| Specific Heat PVC | 9 | J/(g K) |
| Density of PVC | 1.2 | g/cm\hat{ }3 |
| | 0.0012 | g/mm\hat{ }3 |
| Energy Per linear mm | | |
| Volume per linear mm | 1 | mmm\hat{ }3 |
| Weight per linear mm | 0.0012 | g |
| Energy Per linear mm | 0.4812 | J/mm |
| Rate | | |
| 10,000/hr | 1.38 | ft/sec |
| | 420.62 | mm/s |
| Power | 202.40 | Watts |

To run at 10,000 units per hour, 200 watts of energy must be transferred to the PVC. However, not all of the energy from the hot air stream is transferred to the PVC as some of it is lost as warm air. Therefore the heating element that can supply up to 5× the energy would be preferred, (i.e. a 1000 W element).

A nozzle suitable for the present invention is illustrated in FIG. 11, which also illustrates the air flow characteristics through the nozzle. Peak air velocities at the outlet slit were found to approach 1400 in/sec. Velocities at the inlet of the nozzle were much lower.

Although the invention has been described with reference to certain specific embodiments, various modifications thereof will be apparent to those skilled in the art without departing from the purpose and scope of the invention as outlined in the claims appended hereto. Any examples provided herein are included solely for the purpose of illustrating the invention and are not intended to limit the invention in any way. Any drawings provided herein are solely for the purpose of illustrating various aspects of the invention and are not intended to be drawn to scale or to limit the invention in any way.

We claim:

1. A method of deforming a work piece formed of a thermoplastic material, the material having a plastic deformation or glass transition temperature, the method comprising the steps of:
providing at least one of the work pieces on a conveying means;
conveying the at least one work piece in a linear direction under a stream of heated fluid, the heated fluid having a temperature corresponding to the plastic deformation or glass transition temperature of the work piece, wherein the stream of heated fluid is delivered through a slit in a stationary nozzle and applied in the form of a sheet against a surface of the work piece to form a line of weakness on the work piece;
conveying the heated work piece over a form for bending the work piece along the line of weakness to form a formed work piece; and,
cooling the formed work piece at least along the line of weakness to harden the bend.

2. The method of claim 1, wherein the slit of the nozzle has a length that is parallel to the linear direction of the work piece blank.

3. The method of claim 2, wherein the stream of heated fluid has a thickness.

4. The method of claim 3, wherein the thickness of the stream corresponds to the width of the slit of the nozzle.

5. The method of claim 2, wherein the line of weakness has a thickness corresponding to the thickness of the stream of heated fluid.

6. The method according to claim 5, wherein the stream thickness is less than 2 millimetres.

7. The method according to claim 1, wherein the work piece is made of polyvinyl chloride (PVC).

8. The method according to claim 7, wherein the stream of heated fluid has a temperature between 65° C. and 94° C.

9. The method according to claim 1, wherein the work piece is bent at an angle between 0 and 180 degrees.

10. The method according to claim 1, wherein the conveying means is a conveyor belt.

11. The method according to claim 1, wherein a plurality of work pieces are provided, wherein the workpieces are fed to the conveying means.

12. The method according to claim 11, wherein the conveying means conveys about 10,000 work pieces per hour.

13. The method according to claim 1, wherein the form comprises a stationary guide.

14. An apparatus for deforming a work piece formed of a thermoplastic material, the material having a plastic deformation or glass transition temperature, the apparatus comprising:
a conveyor for receiving and conveying at least one of the work pieces along a linear direction;
at least one stationary nozzle positioned at a first position of the conveyor, the nozzle having a slit and being operable to deliver a stream of heated fluid through the slit in the form of a sheet against the work piece for locally heating a portion of the work piece to form a line of weakness on the work piece;
the nozzle being aligned with the conveyor whereby the length of the slit is parallel to the linear direction;
a form positioned at a second location of the conveyor, downstream of the first position along the linear direction, the form being adapted to bend the work piece along the line of weakness as the workpiece is conveyed there-over;
a cooling station positioned at a third location of the conveyor, downstream of the second position along the linear direction, the cooling station being adapted to cool at least the line of weakness to harden the bend.

15. The apparatus according to claim 14, wherein the form is adapted to bend the work piece at an angle between 0 and 180 degrees.

16. The apparatus according to claim 14, further comprising a dispensing unit for dispensing the work pieces onto the conveyor.

17. The apparatus according to claim 16, wherein the apparatus is adapted to process about 10,000 work pieces per hour.

18. The apparatus according to claim 17, wherein the form comprises a stationary guide.
